(19) United States
(12) Patent Application Publication
(10) Pub. No.: US 2008/0003378 A1
(43) Pub. Date: Jan. 3, 2008

(54) Fluid jet printing recording media layers

(75) Inventors: Mark Serafin, Apple Valley, MN (US); Stephen R. Ebner, Stillwater, MN (US); David C. Lowery, Roberts, WI (US); Neal K. Nelson, Stillwater, MN (US); Michael Steiner, New Richmond, WI (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/479,786

(22) Filed: Jun. 30, 2006

(51) Int. Cl. H01F 1/00

(52) U.S. Cl. 427/599

(57) ABSTRACT

Producing magnetic-recording media includes providing a substrate and forming a plurality of functional layers over the substrate to provide a coated substrate adapted for recording. At least one of the layers of the magnetic-recording media is fluid jet printed as a printed layer. In some embodiments, the printed layer provides at least one of load-bearing functionality, head-cleaning functionality, adhesion-promoting functionality, reaction-promoting functionality, lubricating functionality, surface-cleansing functionality, magnetic-recording functionality, and edge-finishing functionality.

### THE FIELD OF THE INVENTION

The present invention generally relates to recording media. More particular, the present invention relates to fluid jet printing one or more recording medium layers, such as magnetic-recording medium layers.

### BACKGROUND OF THE INVENTION

In general, recording media and, more particularly, magnetic-recording media, include one or more layers on a substrate, such as a magnetic-recording layer formed over the substrate. The layers within magnetic-recording media include, for example, antistatic material, abrasive materials that aid the cleaning of recording heads during use, lubricating materials that reduce friction between a magnetic-recording head and surfaces of the magnetic-recording medium, or combinations thereof. Additional fluid layers may be incorporated in magnetic-recording media as desired to address media performance, ease of coatability, or productivity, for example. In particular, functional materials can be incorporated in discrete fluid layers which are layered over the substrate to provide functional layers. Alternatively, one or more functional materials can be incorporated in a single fluid layer that, when dried, forms a multi-functional layer in a resulting magnetic-recording medium.

Magnetic-recording media, such as magnetic-recording tapes or disks, typically comprise a front coat coated with a coating head onto at least one surface of a non-magnetic substrate. In certain designs, the front coat is formed as a single layer directly onto the non-magnetic substrate. In an alternative approach, a multi layer front coat is employed. For example, a dual layer front coat often includes a front sublayer coated onto the substrate and a thin magnetic layer coated onto the front sublayer. The two layers may be formed simultaneously or sequentially. The front sublayer is typically non-magnetic and generally includes a non-magnetic powder dispersed in a binder system. Conversely, the magnetic layer includes one or more metal particle powders or pigments dispersed in a binder system. Magnetic-recording media may also have a back coat applied to the opposing side of the non-magnetic substrate in order to improve the durability, electroconductivity, and tracking characteristics of the magnetic-recording media.

### SUMMARY OF THE INVENTION

According to some aspects of the present invention, producing magnetic-recording media includes providing a substrate and forming a plurality of functional layers over the substrate to provide a coated substrate adapted for recording. At least one of the layers of the magnetic-recording media is fluid jet printed as a printed layer. In some embodiments, the printed layer provides at least one of load-bearing functionality, head-cleaning functionality, adhesion-promoting functionality, reaction-promoting functionality, lubricating functionality, surface-cleansing functionality, magnetic-recording functionality, and edge-finishing functionality.

### BRIEF DESCRIPTION OF THE DRAWINGS

FIG. 1 is a schematic side view of an embodiment magnetic-recording medium, in accordance with principles of the present invention.

FIG. 2 is a schematic view of a fluid jet printer for printing one or more functional layers of the magnetic-recording medium of FIG. 1, in accordance with principles of the present invention.

FIGS. 3A-3D are schematic top views of various embodiment print layer patterns, in accordance with principles of the present invention.

FIGS. 4A and 4B are schematic side views of various embodiment printed layer thickness gradients, in accordance with principles of the present invention.

FIGS. 5A and 5B are schematic side views of various embodiment printed layers, in accordance with principles of the present invention.

FIGS. 6A and 6B are schematic side and front views, respectively, illustrating embodiment printed layers of the magnetic-recording medium of FIG. 1, in accordance with principles of the present invention.

### DETAILED DESCRIPTION

The present invention is directed toward fluid jet printing one or more functional layers of a magnetic-recording medium in order to achieve improved magnetic-recording medium performance and/or manufacturability, for example. As such, an initial explanation of magnetic-recording media structures according to principles of the present invention is instructive.

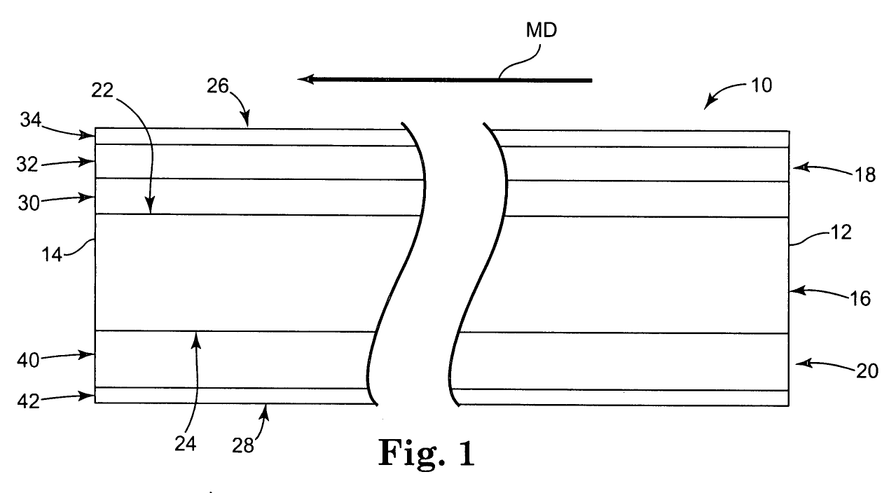

A magnetic-recording medium 10 in accordance with principles of the present invention is shown generally in FIG. 1 from a schematic, side view. The magnetic-recording medium 10 extends lengthwise, or longitudinally, between a first end 12 and a second end 14 and generally includes a substrate 16, a front coat 18, and a back coat 20 serving to provide various magnetic-recording medium functionalities. The magnetic-recording medium 10 can be a magnetic-recording tape, as well as other formats, such as a magnetic-recording disk, including floppy disks and hard disks used in hard drives. Additionally, it should be understood that principles of the present invention can be applied to other recording media such as, for example, magneto optical recording disks and other optical recording media, including DVDs, CDs, and other formats.

With reference to FIG. 1, the substrate 16 defines a top surface 22 and a bottom surface 24 opposite the top surface 22. In general, the substrate 16 is in elongated form and is configured to be reduced into a final format (e.g., tape or diskette) following formation of one or more layers over the substrate 16. As described above, in some embodiments, the substrate 16 and layers associated therewith are reduced to an elongated tape form having a final format width, via a slitting operation, for example. The substrate 16 is alternately reduced to other formats, for example, into a disk format with a punching operation.

The front coat 18 generally extends over and is bonded to the top surface 22 of the substrate 16 and defines a front face 26. The front coat 18 comprises a magnetic component, is adapted for recording, and provides additional functionality as desired. For example, the front coat 18 can be configured to improve durability of the magnetic-recording medium 10, as well as reduce friction between the front coat 18 and read/write mechanisms, for example. The back coat 20 extends under and is bonded to the bottom surface 24 of the substrate 16 and defines a back face 28 opposite the front face 26. In some embodiments, the back coat 20 is configured to improve durability of the magnetic-recording medium 10, as well as reduce the amount of friction between the magnetic-recording medium 10 and read/write mechanisms, for example, read/write mechanisms of a tape drive. The back coat 20 also provides additional functionality as desired, such as head-cleaning functionality (e.g., cleaning the read/write mechanisms) or potentially magnetic-recording functionality in some embodiments.

The front coat 18 and the back coat 20 can each be formed as a multi layer or a single layer construction. In some embodiments, the front coat 18 includes a front sublayer 30 and a recording layer 32. As will be described in greater detail below, the front coat 18 optionally includes additional functional layers, such as a front outer surface layer 34 defining the front face 26, though the front coat 18 can also be formed as a single layer or dual layer construction, for example, with the recording layer 32 defining the front face 26. In general relational terms, the front sublayer 30 extends over and is bonded to the top surface 22 of the substrate 16 with the recording layer 32 extending over and being bonded to the front sublayer 30. In turn, the front outer surface layer 34 extends over and is bonded to the recording layer 32 to define at least a portion of the front face 26. Additionally, in various embodiments, one or more functional layers are optionally interposed between the substrate 16 and the front sublayer 30, between the front sublayer 30 and the recording layer 32, and so forth.

In turn, the back coat 20 is formed as a single layer construction for providing various back coat functions or a multi layer construction with multiple layers providing the back coat functions. For example, in some embodiments including a multi layer construction, the back coat 20 includes a back sublayer 40 and a back outer surface layer 42 defining the back face 28. As will be described in greater detail below, the back coat 20 also includes one or more additional layers as desired.

As previously alluded to, the various layers of the magnetic-recording medium 10 (as well as components forming such layers) generally serve one or more roles, or functions, during manufacture and/or use of the magnetic-recording medium 10. For example, functional layers of the magnetic-recording medium 10 serve to provide load-bearing functionality (e.g., via incorporation of load-bearing particles (LBP)), head-cleaning functionality (e.g., via incorporation of abrasive particles or other head-cleaning agents (HCA)), surface-cleansing functionality (e.g., via application of cleansing solvents), adhesion promoting or priming functionality (e.g., via incorporation of adhesion promoters such as binders), lubricating functionality (e.g., via incorporation of lubricants), reaction-promoting functionality (e.g., via incorporation of catalysts, cross-linking agents, and/or other reactive species), and magnetic-recording functionality (e.g., via incorporation of magnetic components), as well as others.

It should be noted that the terms “layer” and “coating” are used interchangeably herein in association with functional layers comprising the front coat 18 and/or the back coat 20 to refer to compositions formed over the substrate 16 to provide a coated substrate, and thus the magnetic-recording medium 10. Additionally, the phrase “formed over the substrate” should be understood to not only include layers formed directly onto the substrate 16, but also layers that are deposited on any of the layers that are part the magnetic-recording medium 10. Generally, the various functional layers are deposited as fluids comprising a non-aqueous solvent, and, if applicable, one or more solutes, such as a binder system. Where a solute is present, the coating solute remains behind upon drying of the selected solvent or solvents. In other words, where solutes are present, the functional layers are applied as liquids for ease of application, but the functional layers are typically dry in the finished product. However, in some embodiments, not all functional layers are formed over the substrate 16 as a fluid. For example, one or more functional layers could be pre-formed and applied as a b-staged film.

Acceptable solvents include, for example, ketones such as acetone and methyl ethyl ketone, methyl isobutyl ketone, cyclohexanone, isophorone; esters such as methyl acetate, ethyl acetate, butyl acetate, isobutyl acetate, isopropyl acetate, ethyl lactate, glycol monoethyl ether acetates; ethers such as diethyl ether, tetrahydrofuran, glycol dimethyl ethers, dioxane; aromatic hydrocarbons such as benzene, toluene, xylene, cresol, chlorobenzene, styrene; chlorinated hydrocarbons such as methylene chloride, ethylene chloride, carbon tetrachloride, chloroform, ethylene chlorohydrin, dichlorobenzene; N,N-dimethylformamide, and hexane; and mixtures thereof.

Where applicable, typical binder systems of the various functional layers of the front and back coats 18, 20 include at least one binder resin, such as a thermoplastic resin, in conjunction with other additives as desired functionality dictates. Acceptable binders include, for example, vinyl chloride vinyl acetate copolymers, vinyl chloride vinyl acetate vinyl alcohol copolymers, vinyl chloride vinyl acetate maleic acid polymers, vinyl chloride vinylidene chloride copolymers, vinyl chloride acrylonitrile copolymers, acrylic ester acrylonitrile copolymers, acrylic ester vinylidene chloride copolymers, methacrylic ester vinylidene chloride copolymers, methacrylic esterstyrene copolymers, thermoplastic polyurethane resins, phenoxy resins, polyvinyl fluoride, vinylidene chloride acrylonitrile copolymers, butadiene acrylonitrile copolymers, acrylonitrile butadiene acrylic acid copolymers, acrylonitrile butadiene methacrylic acid copolymers, polyvinyl butyral, polyvinyl acetal, cellulose derivatives, styrene butadiene copolymers, polyester resins, phenolic resins, epoxy resins, thermosetting polyurethane resins, urea resins, melamine resins, alkyl resins, urea formaldehyde resins, combinations thereof, and others.

The compositions are optionally formed, or layered, over the substrate 16 using a die coating head or other coating methods and systems, such as single or dual slot die coating, slide coating, or gravure coating, for example. However, as will be described in greater detail, in some embodiments, one or more functional layers or “coatings” of the magnetic-recording medium 10 are “jetted” or “printed” by fluid jet printing. For reference, as used herein, the terms “coated substrate” and “coating” should be understood to be inclusive of layers formed via a variety of means, including fluid jet printing.

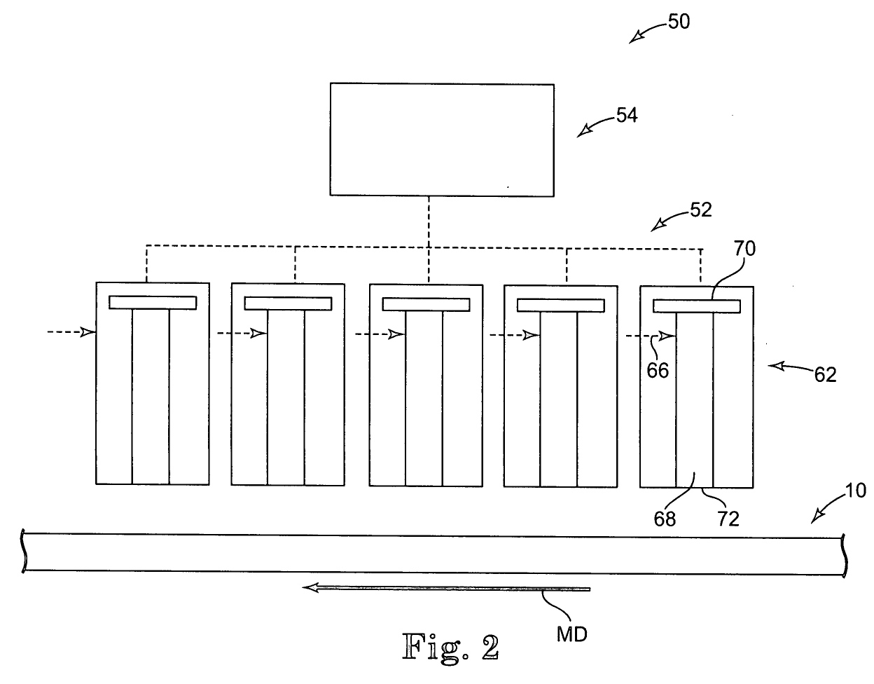

Fluid jet printing generally relates to successively jetting small volumes, or droplets, of material onto a surface. With reference to FIG. 2, a fluid jet printer 50 including one or more fluid jet arrays 52 and a controller 54 for operating the fluid jet array 52 is shown generally in schematic form. The fluid jet array 52 (or arrays) is adapted to eject fluids, including fluid dispersions of particles. The fluid jet array 52 includes a plurality of fluid jet pumps 62 disposed in a single row, a plurality of rows, or any other desired configuration (e.g., a radial pattern, spiral pattern, irregular or random patterns, or others) and one or more fluid sources 66 for providing fluid to the fluid jet pumps 62.

Each pump 62 is connected to a common fluid source 66 or different fluid sources 66 as desired. In this manner, different compositions provided from different sources 66 can be printed using the fluid jet array 52. For example, a first composition or dispersion is optionally printed substantially continuously with a second composition or dispersion printed intermittently in addition to the first composition. Each pump 62 includes a fluid reservoir 68 receiving fluid from a source 66. The particular fluid to be dispensed, or ejected, is forced from the fluid reservoir 68 by an actuator 70 through a nozzle 72. It should also be noted that multiple nozzles 72 per fluid jet pump 62 are contemplated in some embodiments. In one embodiment, the fluid jet array 52 includes one hundred or more nozzles 72 with the nozzles 72 positioned at a spacing of about 0.02 inches, for example. The number of nozzles 72 and/or fluid jet pumps 62 per fluid jet array 52 is generally predicated upon the volume of fluid to be deposited, although other considerations may also play a role in such selections.

In some embodiments, each pump 62 is adapted to eject a droplet of fluid having a volume of from about 3 picoliters to about 80 picoliters, although other adaptations are also contemplated, including smaller or larger droplet ejection volumes. The actuator 70 is piezoelectric, using piezo crystals to force fluid from the fluid reservoir 68, such that the fluid jet array 52 is characterized as a piezoelectric printing jet array. In other embodiments, the actuator 70 is a heating element, such as a resistor, with the fluid jet array 52 being characterized as a thermal printing jet array. Additional actuator types or combinations of actuator types (e.g., combination piezoelectric and thermal printing fluid jet arrays) are also contemplated.

Generally, each pump 62 is adapted to be actuated in a binary fashion, i.e., each pump is actuated to eject droplets of fluid at a desired frequency. If desired, one or more pumps 62 are optionally pulsed, or otherwise rapidly actuated to more rapidly deposit fluid. For example, each pump 62 is optionally adapted to be cycled, or pulsed, to deposit a plurality of fluid droplets at frequencies ranging upward of about 60 kHz, although other frequencies are also contemplated. Additionally, in contrast to some other coating techniques, such as some screen printing or gravure-type coating head techniques of fluid deposition, fluid jet printing provides deposition of a known, predetermined volume of fluid with each actuation, allowing for tighter control and less variation in fluid volume deposited onto a particular magnetic-recording medium surface.

In some embodiments, the fluid jet array 52 is adapted to print onto one or more surfaces of the magnetic-recording medium 10 as the medium 10 is moved past the fluid jet array 52. For reference, the term “magnetic-recording medium 10” as used herein describes a final, dried assembly in final format, as well as the medium in various stages of assembly. In some embodiments, the magnetic-recording medium 10 is moved longitudinally, or lengthwise, adjacent the fluid jet array 52 at speeds upward of 1000 ft/min, although other speeds are also contemplated. The fluid jet array 52 can be maintained on a movable carriage (not shown) for moving the fluid jet array 52 latitudinally, or widthwise, relative to the magnetic-recording medium 10. The terms longitudinally and lengthwise are alternatively described as a machine direction MD, while the terms latitudinally and widthwise are also referred to as a cross-web direction CW. In particular, such usage is often more common where the medium 10 is being conveyed in the machine direction MD, for example, using a web handling system including various rollers and/or other appropriate components (not shown).

In some embodiments, the controller 54 is a microprocessor adapted to actuate the fluid jet array 52, for example, individually operating each actuator 70 or “gang” operating actuators 70 as desired. Further, the controller 54 is programmable and otherwise adapted to actuate the fluid jet array 52 to print various patterns, including timing of actuation and position of the fluid jet array 52, as well as other printing parameters.

In contrast to some methods of coating, such as some slot die coating, slide coating, screen printing, or gravure coating methods, for example, fluid jet printing is operable as a non-contact method of forming layers, wherein the fluid jet array 52 does not otherwise come into contact with or form a fluid bearing extending between a surface onto which fluid is being deposited and a point where fluid is being ejected from the coater. For example, in some embodiments, the fluid jet array 52 is spaced from the surface to be printed on by about 1 mm and does not otherwise contact or form a fluid interface or bearing with a surface being printed on, although smaller and greater offsets are also contemplated, including sufficiently close offsets or operating parameters so as to form a fluid bearing or fluid interface with the printing surface.

As will be understood in greater detail with reference to the text that follows, fluid jet printing is used in various embodiments for forming magnetic-recording medium functional layers. For example, in some embodiments, fluid jet printing allows functional layers to be printed at highly controlled volumes, relatively low and/or uniform thicknesses, pattern printed to define one or more discrete patterns of dots or other shapes, flood printed to define a substantially continuous layer where a relatively large area is substantially covered by the printed layer, printed to define a gradient in layer thickness or pattern thickness, and/or utilized to form layers at various points in a manufacturing process which might otherwise be less amenable to a coating head or other coating equipment. Additionally, fluid jet printing allows deposition of distinct compositions from separate sources as part of a single, functional layer in some embodiments. Unless otherwise indicated or appropriate, print patterns and/or other printed structures described below are descriptive of functional layer characteristics when the functional layer(s) are in a wet state, a dry state, or both, as desired. For example, in some embodiments, a functional layer is printed to define a desired pattern in a wet state following printing, but due to dispersion viscosity or subsequent processing, for example, the functional layer defines a substantially dissimilar pattern or substantially no pattern in a dry state. Alternatively, in other embodiments, a functional layer is printed to define a desired pattern in a wet state and defines a substantially similar pattern in a dry state.

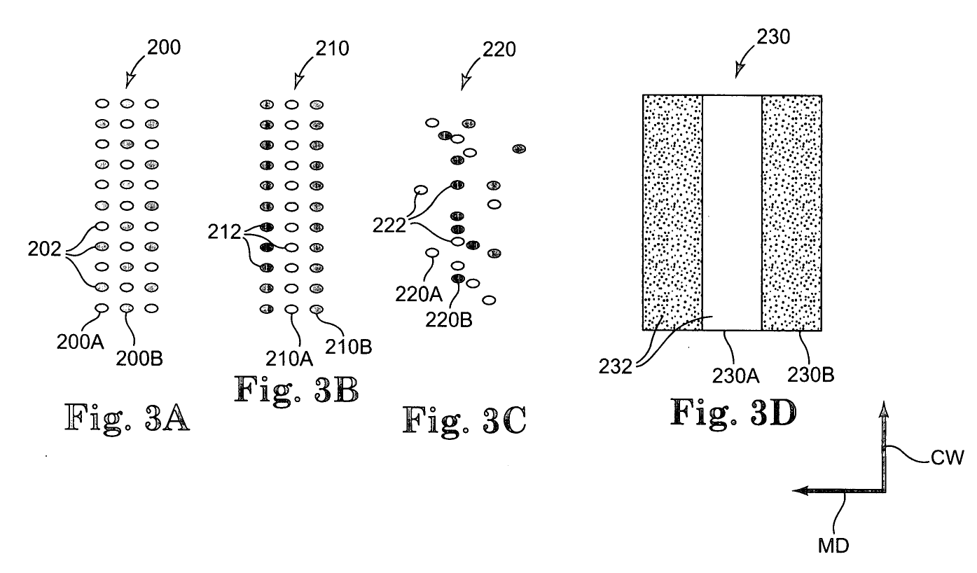

With reference to FIGS. 3A-3D, several embodiment functional layer “wet” and/or “dry” patterns are presented for illustrative purposes, and should be understood as being applicable to the manufacture of any of the functional layers described herein as appropriate. With reference to FIG. 3A, in one embodiment, a first pattern 200 is defined in the machine direction MD and the cross-web direction CW and includes a plurality of dots 202. In one embodiment, each of the dots 202 defines an area of about 715 μm² or less, for example. Regardless, the first pattern 200 is generally representative of one embodiment functional layer that is regularly repeating in both the machine direction MD and the cross-web direction CW. The pattern 200 is characterized by the plurality of dots 202 including a first composition 200A, for example, HCA dispersion, and a second composition 200B, for example, lubricant. The first and second compositions 200A, 200B are distinctly maintained during printing and are deposited in an alternating pattern in both the machine and cross-web directions MD, CW. Thus, in one embodiment, the locations and amounts of HCA and lubricant can be tightly controlled and pre-selected to provide improved head-cleaning functionality and lubricating functionality.

With reference to FIG. 3B, in another embodiment, a second pattern 210 is defined in the machine direction MD and the cross-web direction CW. In particular, the second pattern 210 is representative of a functional layer that regularly repeats in both the machine direction MD and the cross-web direction CW. The second pattern 210 is defined by a plurality of dots 212 of a first composition 210A and a second composition 210B. The first and second compositions 210A, 210B are deposited in an alternating pattern in the machine direction only. In one embodiment, the first composition 210A provides “rough” head-cleaning functionality and is composed of HCA at a first concentration of abrasive particles and/or particles of a first size. In turn, the second composition 210B is optionally adapted to provide a finer head-cleaning functionality, for example, having a higher concentration of HCA and/or particles of a smaller size. Thus, in one embodiment, the locations and amounts of HCA can be tightly controlled and pre-selected to provide improved head-cleaning functionality by roughly abrading a read/write head and finishing, or finely abrading, the read/write head.

With reference to FIG. 3C, in yet another embodiment, a third pattern 220 is defined in the machine direction MD and the cross-web direction CW. The third pattern 220 is representative of a pre-selected pattern that is irregularly repeating, or substantially random, in both the machine direction MD and the cross-web direction CW. The third pattern 220 is defined by a plurality of dots 222 of a first composition 220A and a second composition 220B. The first and second compositions 220A, 220B are alternated in a random pattern in both the machine direction MD and the cross-web direction CW. In one embodiment, the first composition 220A is a binder system and the second composition 220B is a catalyst and/or a cross-linking agent deposited in a random pattern to provide adhesion priming functionality. For example, the randomized pattern and three-dimensional structure of the pluralities of dots 222 can be used to promote mechanical bonding between the functional layer and a layer applied onto the functional layer, with the catalyst and binder system providing desirable chemical bonding characterizations.

With reference to FIG. 3D, in still a further embodiment, a fourth pattern 230 is regularly defined in the machine direction MD. The fourth pattern 230 is representative of a functional layer that is regularly repeating in the machine direction MD only. The second pattern 202 is defined by a series of flood prints or bands 232 of a first composition 230A and a second composition 230B. The first and second compositions 230A, 230B are regularly alternated in the machine direction MD only. In one embodiment, the first composition 230A provides “rough” head-cleaning functionality and is composed of HCA at a first concentration of abrasive particles of a first size. In turn, the second composition 230B is optionally adapted to provide a finer head-cleaning functionality, for example, having a higher concentration of HCA of a smaller size. Thus, in one embodiment, the locations and amounts of HCA are flood printed in a pattern with locations and deposition amount tightly controlled and pre-selected to provide improved head-cleaning functionality, for example, by allowing a read/write head to be roughly abraded and also finished, or finely abraded, for example.

Additionally, the functional layers can be printed to define a variety of thicknesses. In some embodiments, the functional layers are printable at the minimum printable volume the fluid jet pumps 62 are adapted to dispense, for example, about 3 picoliters or even less. However, fluid jet printing can also be used to form relatively thick functional layers. For example, increasing the number of fluid jet pumps 62 activated, and/or by actuating the fluid jet pumps 62 at higher frequencies, more fluid is deposited on a surface, which allows formation of thicker layers. In this manner, fluid jet printing is usable to print functional layers substantially thinner than those readily formed using some coating methods, such as some slot die coating and slide coating methods, but can also be used to print at substantially the same thickness as such other methods.

Furthermore, in some embodiments, gradients in functional layer thickness in either the machine direction MD or the cross-web direction CW are realizable using fluid jet printing. For example, methods of coating using a coating head such as dual slot die coaters are difficult, if not sometimes impossible, to employ to generate predetermined patterns or controlled gradients in layer thickness, and particularly in the machine direction MD.

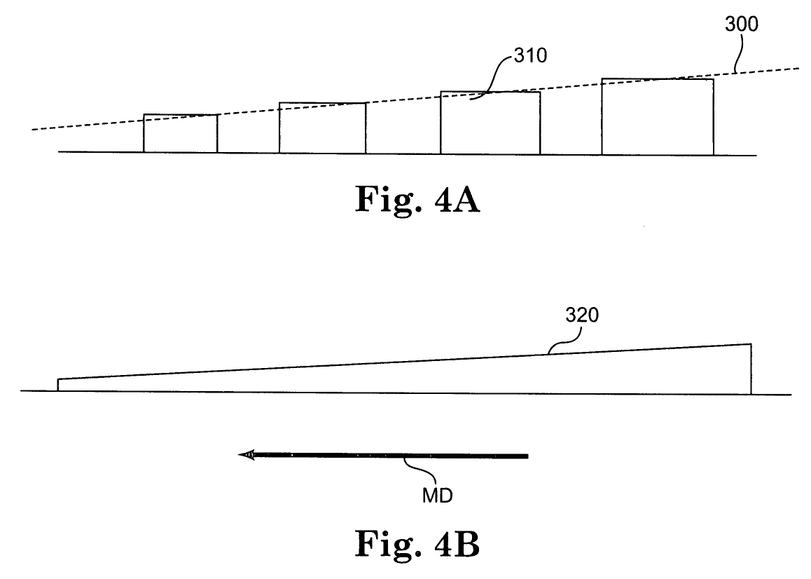

With reference to FIG. 4A, in one embodiment, a first gradient in thickness 300 is defined by a graduating pattern of printed structures 310. The thicknesses of the structures 310 are optionally varied, for example, by varying a number and/or frequency of activation of the fluid jet pumps 62 used to deposit fluid. With reference to FIG. 4B, in another embodiment, a second gradient in thickness 320 is defined as an increase in thickness of a substantially continuous layer. In some embodiments, the first and second gradients 300, 320 are defined in the machine direction MD and are substantially linear in overall slope. However, it should be understood that in some embodiments, gradients that define stepwise, curvilinear, undulating, and other shapes are defined. Further, gradients in thickness are additionally or alternatively defined in the cross-web direction CW. As referenced above, gradients are optionally defined in a wet state, a dry state, or both.

In some embodiments, fluid jet printing is used to deposit embedded layer patterns as well as external, or exposed, pattern layers at the front and/or back faces 26, 28 of the magnetic-recording medium 10. For example, a functional layer including components that are environmentally sensitive can be embedded within another functional layer or as part of a single functional layer. Additionally, a functional layer that includes reactive components, for example, a binder system and a catalyst and/or a cross-linking agent, can be formed with the reactive components embedded or otherwise printed as layers on top of one another for extremely precise and controlled reactions, such as migrant catalytic, free radical, and other reactions. Additionally, problems such as coating head “gumming,” where products of reactions alter viscosity and cause coating problems are more readily avoided. For example, such “gumming” problems can be reduced or avoided by fluid jet printing reactive species, such as a catalyst and/or cross-linking agent and a binder from separate fluid sources onto a surface, rather than pre-mixing the reactive species prior to deposition.

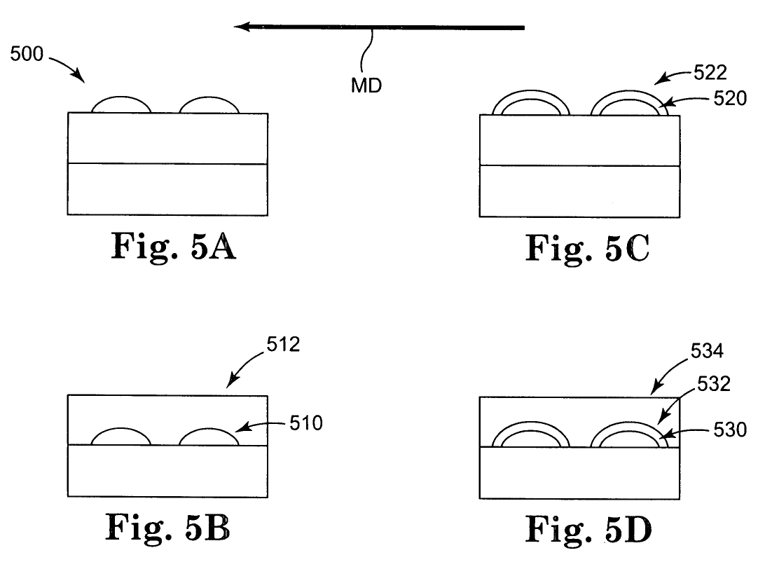

As a general example of an external, or exposed, pattern layer, FIG. 5A illustrates a schematic of one embodiment with a first functional layer 500 defining a printed pattern deposited as an outermost layer, for example, at the front face 26 of the magnetic-recording medium 10 (FIG. 1). As a general example of an embedded layer, FIG. 5B illustrates a schematic of a first functional layer 510 defining a printed pattern, where the first functional layer 510 is embedded within a second functional layer 512 that is substantially continuous. As previously described, continuous functional layers are optionally fluid jet printed as a flood print or coated over the functional layer 510 using other coating systems and methods, for example, die coating or slide coating.

As another example of an embedded layer, FIG. 5C illustrates a first functional layer 520 defining a print pattern, where the first functional layer 520 is embedded within a second functional layer 522, the second functional layer 522 also defining a print pattern according to one embodiment. In particular, the second functional layer 522 is deposited as an outermost layer and is patterned over the first functional layer 520. As yet another example of an embedded layer, FIG. 5D illustrates one embodiment of a first functional layer 530 defining a print pattern, wherein the first functional layer 530 is embedded within a second functional layer 532 defining a print pattern over the first functional layer 530. Further, the first and second functional layers 530, 532 are both embedded within a third functional layer 534, where the third functional layer 534 is deposited as a substantially continuous layer 534.

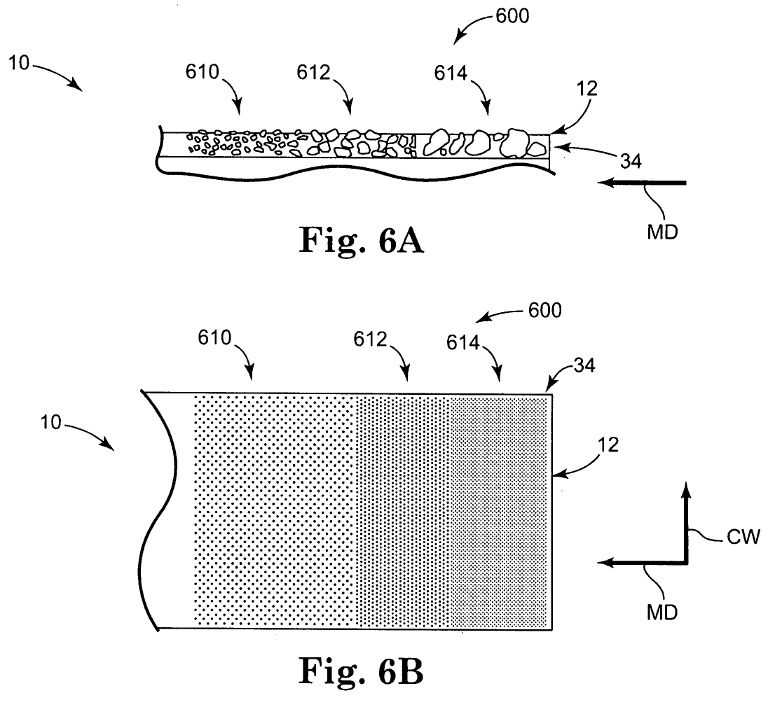

Further, in some embodiments, one or more functional layers are printed with pre-selected gradients in particle size in the machine direction MD. For example, the fluid jet array 52 is optionally actuated to create a substantially continuous gradient in mean particle size within a functional layer in the longitudinal direction. Alternatively, the fluid jet array 52 is used to define a step-wise gradient in mean particle size, with several distinct regions having different mean particle sizes (see, e.g., FIG. 6A and associated description that follows).

Further still, in some embodiments, a functional layer is printed at multiple resolutions or at a pre-selected gradient in resolution. In one embodiment, the gradient in resolution is substantially continuous, e.g., changing gradually longitudinally along the magnetic-recording medium 10. Alternatively, a step-wise gradient in resolution is contemplated, with several distinct regions having different print resolutions (see, e.g., FIG. 6B and associated description that follows). For reference, as used herein, “resolution” is optionally measured as “dots per inch” (DPI). DPI is a measure of fluid jet printing resolution and, in particular, a number of individual droplets of fluid produced within a linear one-inch space on a surface.

Although the preceding patterns and shapes described are generally basic in nature, it should be understood that more complex patterns and shapes are also contemplated and the above examples are presented for illustrative purposes. For example, embedded and/or surface patterns comprising machine readable patterns (e.g., printed bar codes or security features) as well as human readable patterns (e.g., symbols) are also contemplated.

With the above in mind, and with general reference to FIG. 1, a method of producing the magnetic-recording medium 10 is described in greater detail. In some embodiments, the method of producing the magnetic-recording medium 10 generally includes providing the substrate 16, forming a plurality of functional layers (e.g., the layers forming the front coat 18 and/or the back coat 20) over the substrate 16 to provide a coated substrate with at least one of the functional layers being fluid jet printed, and reducing the coated substrate to a final format (e.g., tape or disk). In some embodiments, the method also includes surface treating the coated substrate. It should also be noted that one or more functional layers are optionally formed following surface treatment (if applicable) and/or following reduction to final format with portions of the method performed in-line or off-line as desired.

In some embodiments, providing the substrate 16 includes unwinding the substrate 16 or related material from a spool or supply and transporting, or moving, the substrate 16 in the machine direction MD along a web path with a web handling system (not shown), for example, at about 1000 ft/min, although other speeds are also contemplated.

The substrate 16 can be any conventional non-magnetic substrate useful as a support for a particular magnetic-recording medium format. Examples of substrate materials useful for magnetic-recording medium formats include polyesters such as polyethylene terephthalate (PET), polyethylene naphthalate (PEN), a mixture of polyethylene terephthalate and polyethylene naphthalate, polyolefins (e.g., polypropylene), cellulose derivatives, polyamides, and polyimides, for example.

In some embodiments, forming the plurality of functional layers over the substrate 16 to provide a coated substrate includes forming the functional layers comprising the front coat 18 and the back coat 20 as well as other functional layers, such as a surface-cleansing functional layer, as described below. At least one functional layer is formed over the substrate 16 via fluid jet printing using one or more fluid jet arrays, such as fluid jet array 52. If desired, substantially all of the functional layers of the magnetic-recording medium 10 are formed via fluid jet printing. However, it is contemplated that one or more functional layers are formed over the substrate 16 using other coating techniques, such as slide coating or slot die coating, for example.

In some embodiments, the fluid jet array 52 is adapted for dispensing a cleanser, for example, a solvent cleanser, such as the solvents described above. In some embodiment surface-cleansing operations, the fluid jet array 52 is positioned along the web path following unwinding of the substrate 16, or alternatively, the fluid jet array 52 is utilized to deposit the surface-cleansing layer(s) as part of an offline operation. The substrate 16 is optionally cleansed prior to application of the front and/or back coats 18, 20. In particular, one or more functional layers having surface-cleansing functionality are formed over the substrate, onto the top and/or bottom surfaces 22, 24 of the substrate 16 via fluid jet printing. It should also be understood that such “surface-cleansing layers” are optionally formed over the substrate 16, onto one or more functional layers following their formation.

In some embodiments, the surface-cleansing layer or layers are substantially free from solutes such as binders, lubricants, and particles, for example, load-bearing particles (LBPs), head-cleaning agents (HCAs), or magnetic particles. The cleanser is jetted onto the substrate 16 (or other surface to be cleansed) as a flood print, as a patterned print (e.g., a plurality of dots), or combinations thereof, including any of the patterns or configurations described herein.

In order to help ensure sufficiently fast drying, the cleanser can be applied as an extremely thin layer, for example, a sufficient thickness to be substantially continuous, yet thin enough to substantially immediately flash off following deposition or dry within another desired time. Surface-cleansing layer drying is also optionally facilitated with an in-line oven or with other drying means prior to formation of additional layers.

In some embodiments, the back coat 20 is formed over the substrate 16 prior to formation of the front coat 18. However, it should be understood that the back coat 20 may be formed subsequently to the front coat 18. Further, portions of the front coat 18 and back coat 20 may be substantially simultaneously formed. For example, a front coat and back coat layer can be substantially simultaneously printed. Additionally, portions of the front coat 18 may be formed prior to the back coat 20 with other portions of the front coat 18 formed after formation of the back coat 20, and so forth.

As previously described, the back coat 20 is optionally formed over the substrate 16 as a single layer having multiple functionalities, or as multiple layers each having one or more functionalities. In some embodiments including a multi-layer construction, both the back sublayer 40 and the back outer surface layer 42 are formed over the substrate 16. However, it should be understood that a single layer construction is also contemplated, for example, “combining” functionalities of the back sublayer 40 and the outer surface layer 42 into a single layer. Additionally, in some embodiments, the back coat 20 includes one or more functional layers serving adhesion-promoting functionality as part of the back sublayer 40, part of the outer surface layer 42, or as a separate layer or layers from the back sublayer 40 and outer surface layer 42 as desired.

For example, an appropriate binder system and solvent are optionally employed to provide a surface priming dispersion that is fluid jet printable to form a functional layer serving, at least in part, as a primer layer. The binder or binders are dispersed in a non-aqueous organic solvent, for example. A surfactant or wetting agent and one or more hardening agents can be included, as well as any lubricants, LBP, HCA, or other components, such as catalysts, as desired. In some embodiments, the primer layer is a specialized functional layer which primarily serves as an adhesion promoter. In particular, the functional layer can be “specialized” by being substantially binder system rich, for example, comprising up to about 100 weight percent (wt %) of a binder system or systems or other adhesion-promoting agents in the wet state, dry state, or both.

In some embodiments, the primer layer is formed over the substrate 16, for example, on the bottom surface 24 of the substrate 16, as a pattern of dots via fluid jet printing or as any of the patterns and/or flood prints described herein. The primer layer can serve to enhance chemical as well as mechanical bonding mechanisms. For example, by forming a three dimensional structure, mechanical bonding can be promoted and an appropriate primer can be selected to promote chemical bonding. Additionally, the print pattern can be randomized to further increase mechanical bonding as should be understood by those of skill in the art in view of the teachings provided herein. It should also be understood that multiple consecutive layers can also be utilized for adhesion-promoting functionality. For example, a first primer layer can be flood printed onto the substrate 16 with thermal drying or b-staging or UV curing or b-staging after formation of the first primer layer. In some embodiments, a second, subsequent patterned primer layer can be formed over the first primer layer to add additional structure as desired.

With the multi-layer construction, the back sublayer 40 is formed over the substrate 16 using a coating head, such as a coating die, using fluid jet printing, or via other means. In some embodiments, the back sublayer 40 includes one or more carbon black components in combination with appropriate binder resins, such as those previously described. The back sublayer 40 also includes lubricants, head-cleaning agents (HCA), or other components as desired.

In some embodiments, the back outer surface layer 42 is sequentially formed over the substrate 16 onto the back sublayer 40 using fluid jet printing. The back sublayer 40 can be dried prior to application of the back outer surface layer 42, i.e., wet-on-dry formation. However, wet-on-wet formation of the back outer surface layer 42 onto the back sublayer 40 is also contemplated.

In some embodiments, the back outer surface layer 42 dispersion is optionally fluid jet printable and comprises load-bearing particles, with or without the inclusion of lubricants and/or other components, together with requisite solvents and binders compatible with the back coat sublayer 40. Appropriate load-bearing particles include, for example, carbon, graphite, silicon dioxide, molybdenum disulfide, barium sulfate, calcium carbonate, silicone beads, polymethacrylate beads, combinations thereof, and others. In some embodiments, the load-bearing particles of the back outer surface layer 42, alone and/or in agglomerated state, do not exceed an absolute size of from about 1 μm to about 3 μm. However, other suitable sizes for fluid jet printing (e.g., sized to avoid prematurely plugging the jetting nozzles) are also contemplated.

By subsequently applying the load-bearing particle dispersion of the back outer surface layer 42 onto the back sublayer 40, load-bearing particles of the back outer surface layer 42 are more apt to be located proximate to the back face 28 of the magnetic-recording tape 10. In contrast, where the load-bearing particles are added to the carbon dispersion of the back sublayer 40 and die coated as a part of the carbon dispersion of the back sublayer 40, the load-bearing particles dispersed within the back coat 20 dispersion coating are typically not all at, or near, the back face 28 and consequently relatively less load-bearing functionality is provided to the back coat 20. Additionally, larger load-bearing particles may otherwise be required to promote load-bearing functionality at the back face 28 in the absence of such a “targeted” approach.

Fluid jet printing the functional layers of the back coat 20 provides a relatively high degree of control over layer formation. For example, the functional layers are printable through a wide range of thicknesses and patterns, so as to, for instance, space deposition of load-bearing particles (LBP) in the machine direction MD, cross-web direction CW, and/or z-direction (i.e., in the direction of the thickness of the functional layer) in a pre-selected manner, including any of the printed patterns, gradients in thickness, and other printed layer constructions described herein. Additionally, a functional layer can be printed onto a previously formed layer at locations that are not otherwise in close proximity to a location where the previous coating layer has been formed, in contrast to some coating methods, such as dual slot die coating.

In particular, in some embodiments, the functional layers need not be formed one shortly following the other. This may result, in part, because typical die coating considerations, such as dispersion viscosity of a previously formed layer, for example, are not as relevant to layer formation with fluid jet printing according to some embodiments. Thus, the fluid jet array 52 can be positioned at different locations along the web path in some embodiments, where many wet-on-wet coating operations can require relatively close proximity between locations where the back sublayer 40 is formed and where the back outer surface layer 42 is subsequently formed onto the back sublayer 40, for example. Further, fluid jet printing is easily amenable to applying fluid dispersions onto a dry coating (wet-on-dry) under controlled conditions, and with a small amount of product. Indeed, formation of the two layers 40, 42 need not even occur in-line, along the same web path, or otherwise as part of a substantially continuous formation process.

As with the back coat 20, the front coat 18 is formed over the substrate 16 as a single layer with multiple functionalities or as multiple layers each exhibiting one or more functionalities. In some embodiments, the front coat 18 includes one or more functional layers serving adhesion-promoting functionality as part of the front sublayer 30, part of the magnetic-recording layer 32, or as a separate layer or layers from the front sublayer 30 and magnetic-recording layer 32 as desired. Principles of manufacture and design of the embodiment primer layers described in association with the back coat 20 are equally applicable to various embodiment primer layer(s) of the front coat 18, and are left from further discussion.

In some embodiments, the front sublayer 30 is essentially non-magnetic. As used herein, “essentially non-magnetic” is indicative of a coercivity of less than about 300 Oe. For reference, “coercivity” and “magnetic coercivity” are synonymous, are abbreviated Hc, and refer to the intensity of the magnetic field needed to reduce the magnetization of a ferromagnetic material to about zero after the material has reached magnetic saturation. Essentially non-magnetic materials include a non-magnetic or soft magnetic component and a resin binder system. As used herein, the term “soft magnetic component” refers to a magnetic component having a coercivity of less than about 300 Oe. By forming the front sublayer 30 to be essentially non-magnetic in a dry state, the electromagnetic characteristics of the recording layer 32 are not substantially adversely affected. However, to the extent that no substantial adverse effect is caused, the front sublayer 30 may contain a small amount of magnetic powder.

The front sublayer 30 may also include at least one of a primary pigment material, conductive carbon black, an abrasive or head-cleaning agent, a binder resin, a head-cleaning agent binder, a reaction-promoting agent, such as a catalyst or cross-linking agent, a lubricant, and/or solvents. The materials for the front sublayer 30 are mixed and the front sublayer 30 is subsequently formed over the substrate 16 onto the top surface 22 of the substrate 16, or onto a separate primer layer where applicable. As with the other functional layers, the front sublayer 30 is optionally coated with a coating head, for example, or fluid jet printed as a flood print, a pattern print, with a gradient in thickness, or according to any of the printed layer constructions described herein as appropriate.

In some coating operations using a coating head, the front coat 18 and, in particular, the magnetic-recording layer 32 and the front sublayer 30 are formed as part of a multi-layer, wet-on-wet coating process, such as slide coating or dual slot die coating, for example. However, as previously referenced, in contrast to dual slot die coating or slide coating, for example, with fluid jet printing, the magnetic-recording layer 32 is possibly applied at a separate and non-proximate location along the web path from where the front sublayer dispersion is deposited along the web path. In some embodiments, the magnetic-recording layer 32 is fluid jet printed onto the front sublayer 30 as part of a wet-on-wet operation, where the fluid jet array 52 is not in close proximity to a point on the web path where the front sublayer 30 is being formed.

However, in some embodiments, the front sublayer dispersion is formed over the substrate 16 and dried and/or cured. Following drying of the front sublayer 30, the magnetic-recording layer 32 is then deposited using fluid jet printing as part of a wet-on-dry operation, which can be in-line or off-line with deposition of the front sublayer 30. With either the wet-on-wet or the wet-on-dry methodologies, it is contemplated that the relatively low thickness variability and/or small thicknesses at which the magnetic-recording layer 32 is potentially fluid jet printed may help reduce any uniformity of thickness concerns with respect to the magnetic-recording layer 32, as well as other functional layers. For example, providing the magnetic-recording layer 32 with a more uniform thickness can improve magnetic flux modulation characteristics of the magnetic-recording medium 10. However, predetermined thickness gradients or other pre-selected changes in thickness of the magnetic-recording layer 32 are also contemplated.

For reference, if the degree of magnetic flux varies across the surface of a magnetic-recording layer 32, the magnetizations written to the layer may exhibit a different signal-to-noise ratio. Accordingly, the applicable noise floor for readout must assume a worst case, generally hampering increased storage densities and recording performance. Magnetic flux can vary, in particular, due to thickness variations in the magnetic-recording layer 32. This type of variation can influence the amount of magnetizable material within a given volume of the magnetic-recording layer 32. Thus, some embodiments with relatively low thickness variation in the magnetic-recording layer 32 can provide more desirable magnetic flux modulations.

Additionally, in some embodiments where the magnetic-recording layer 32 is formed onto the front sublayer 30 as part of a wet-on-dry operation, the magnetic-recording medium 10 can be surface treated (e.g., calendered with calendering rolls) prior to formation of the magnetic-recording layer 32. The front sublayer 30 is dried or dried and cured, for example, using traditional ovens prior to surface treatment. Alternately, the sublayer 30 can be made UV curable and UV cured (including b-staging) in a UV cure station along the web path. It should also be noted that the magnetic-recording layer 32 is also optionally made UV curable. Alternatively, in some embodiments, surface treatment, such as calendering, ensues following formation of the magnetic-recording layer 32.

As previously referenced, the magnetic-recording layer 32 is formed over the substrate 16 onto the front sublayer 30 as part of a wet-on-wet operation or as part of a wet-on-dry operation. The magnetic-recording layer 32 is optionally coated onto the front sublayer 30 using a coating head, for example, or fluid jet printed onto the front sublayer 30 according to any of the print patterns, gradients in thickness, or other constructions described herein and as appropriate.

In some embodiments, the dried and processed magnetic-recording layer 32 has a final thickness from about 0.03 μm to about 0.25 μm or from about 0.05 μm to 0.15 μm as desired, although other thicknesses are contemplated. The recording layer 32 is optionally formed to have a remanent magnetization-thickness product (Mr*t) of less than about 2.5 memu/cm² or less than about 2.1 memu/cm² in the dried state. The term “remanent magnetization-thickness product” refers to the product of the remanent magnetization after saturation in a strong magnetic field (796 kA/m) multiplied by the thickness of the magnetic layer coating. In some embodiments, the dry magnetic-recording layer 32 is characterized by a coercivity greater than 300 Oersteds (Oe), greater than 2000 Oe, or greater than 2300 Oe, for example, although other coercivities, including higher values, are contemplated.

In some embodiments, the magnetic-recording layer 32 also includes an abrasive component, such that the recording layer 32 serves to provide head-cleaning functionality as well as magnetic-recording functionality. If desired, the head-cleaning agent component of the magnetic-recording layer 32 can be substantially reduced, or even substantially omitted, with the front outer surface layer 34 providing head-cleaning functionality to the front coat 18 as described in greater detail below. Similarly, lubricants or other additives otherwise included in the recording layer 32 may be reduced or omitted and included in the front outer surface layer 34, or within multiple functional layers defining the front outer surface layer 34.

Regardless, in some embodiments, the dispersion of magnetic pigments of the recording layer 32 highly comprises one or more magnetic components. For example, the recording layer 32 is formed to include about 75 wt % magnetic components in the dry state in some embodiments, although other values are also contemplated. As alluded to above, in order to achieve higher magnetic component concentrations without unacceptably reducing other recording layer characteristics, such as adhesion to any underlying layer(s), the recording layer 32 optionally has reduced amounts, or even is substantially free of head-cleaning agents, lubricants, load-bearing particles, and/or other components as desired.

In some embodiments, the magnetic particles are prepared as a concentrated magnetic particle dispersion prior to addition of binders and/or solvents, such as those previously described. The concentrated magnetic particle dispersion can be prepared, for example, using dispersing machines, such as high speed impeller mills, attritors, sand mills, and others. The concentrated magnetic particle dispersion can be diluted with a suitable non-aqueous organic solvent to make a magnetic coating composition suitable for fluid jet printing. Typically, the non-aqueous organic solvent has dissolved or dispersed therein a binder, such as those described above. In addition, the various dispersion particles, alone and/or in agglomerated state, can be relegated to an absolute size not exceeding from about 1 μm to about 5 μm. In some embodiments, reduced particle size helps reduce premature plugging of the fluid jet array 62.

At some point following formation of the magnetic-recording layer 32, the magnetic-recording medium 10 is magnetically orientated and dried (UV cured where applicable). More specifically, the recording layer 32 is orientated by being advanced through one or more magnetic fields to generally align the magnetic orientation of the metal particles of the recording layer 32. In one example, each magnetic field is formed by electric coils and/or permanent magnets. One measure of orientation, “Orientation Ratio” refers to the ratio of remanent magnetization at zero applied magnetic field after saturation in a strong magnetic field (796 kA/m) measured in the direction parallel to the intended direction of transport of the recording medium 10 to the corresponding quantity measured in the direction transverse (i.e., perpendicular, but in the plane of the magnetic-recording medium 10) to that of the intended transport of the magnetic-recording medium 10. In one embodiment, the fully processed, dry recording layer 32 has an Orientation Ratio of greater than about 2.2 or greater than about 2.4, for example.

The front outer surface layer 34 is optionally applied over the magnetic-recording layer 32. In some embodiments, surface treatment prior to the application of the front outer surface layer 34 may reduce wear on calendering rolls, for example, where the front outer surface layer 34 includes head-cleaning agents. For reference, typically surface treating includes using steel-on-steel (SOS), compliant-on-steel (COS), or compliant-on-compliant (COC) calender rolls, and combinations thereof as part of an in-line or off-line process, or combinations thereof. The head-cleaning agent particles of the front outer surface layer 34 are relatively abrasive, such that calendering following application of the magnetic-recording layer 32, but prior to application of the front outer surface layer 34, can reduce wear on calendering rolls, as the calendering rolls do not come into contact with the abrasive head-cleaning agent particles.

Calendering can be performed in-line and/or off-line following formation of the magnetic-recording layer 32 or at another stage in producing the medium 10. In some embodiments, after in-line calendering, off-line calendering includes passing the magnetic-recording medium 10 through a series of generally non-compliant rollers, e.g., multiple steel rollers.

Regardless, the front outer surface layer 34 is optionally formed following formation of the magnetic-recording layer 32, for example, either following or prior to magnetic orientation where applicable. In some embodiments, the dry, front outer surface layer 34 is essentially non-magnetic and includes a non-magnetic or soft magnetic component or powder and a resin binder system. As previously referenced, the term “essentially non-magnetic” relates to a coercivity of less than about 300 Oe. Additionally, the top outer surface layer 34 can be formed to be relatively thin. In some embodiments, by forming the top outer surface layer 34 to be relatively thin and/or essentially non-magnetic when dry, the electromagnetic characteristics of the recording layer 32 are not substantially adversely affected. Alternatively, or additionally, the outer surface layer 34 can be formed to define a pattern to reduce electromagnetic interference with the recording layer 32. For example, in one embodiment, the outer surface layer 34 is optionally formed as “strips” extending longitudinally along each edge of the magnetic-recording medium 10, or intermittent strips extending latitudinally between each edge of the medium 10.

Regardless, the front outer surface layer 34 is formed as part of a wet-on-wet operation or as part of a wet-on-dry operation (i.e., following drying and/or curing of the magnetic-recording layer 32). In some embodiments, the front outer surface layer 34 provides at least one of load-bearing functionality, including one or more load-bearing particle components; head-cleaning functionality, including one or more head-cleaning agent components; lubricating functionality, including one or more lubricants, and reaction-promoting functionality, including one or more reactive species such as cross-linking agents and/or catalysts. Additionally, if desired, the front outer surface layer 34 is optionally formed as multiple functional layers providing the one or more functionalities, such as those referenced above.

In some embodiments, the front outer surface layer 34 is a single layer construction including a lubricant or a multi-layer construction including a functional lubricating layer separately deposited. Examples of useful lubricants include, but are not limited to, C₁₀ to C₂₂ fatty acids, C₁ to C₁₈ alkyl esters of fatty acids, and mixtures thereof; silicone compounds such as silicone oils, fluorochemical lubricants, fluorosilicones; particulate lubricants such as powders of inorganic or plastic materials; myristic acid, stearic acid, palmitic acid, isocetyl stearate, oleic acid, and butyl and amyl esters thereof; and mixtures thereof, including mixtures of fatty acids and fatty esters.

In some embodiments, the lubricants are dispersed as a fluid dispersion, for example, in a solvent such as those previously described and fluid jet printed onto the magnetic-recording layer 32. In some embodiments, the lubricating layer is fluid jet printed onto the magnetic-recording layer 32 following drying and/or curing of the magnetic-recording layer 32, although pattern printing is also contemplated. The lubricating layer is optionally formed as part of a head-cleaning layer (described below) or is formed as a separate, specialized functional layer highly comprising the lubricant or lubricants, such as comprising up to about 100 wt % or more lubricant materials.

In use, the ability to apply a lubricating layer separately from the magnetic-recording layer 32 at locations along the web path, such as following or during drying of the magnetic-recording layer 32, can help reduce undesirable lubricant absorption by magnetic pigments in the magnetic-recording layer 32, for example, among other advantages. Although, in some embodiments, it is contemplated that lubricant will be absorbed into layers onto which it is deposited, it should also be understood that over absorption of the lubricant can result in lubricant not being as available at the front face 26 of the front coat 18 to provide sufficient and/or efficient lubricating functionality. For reference, it should also be understood that lubricants/lubricating layers are optionally similarly formed over the substrate 16 via fluid jet printing as part of the back outer surface layer 34 to help ensure sufficient and/or more efficient lubricating functionality at the back face 28.

In some embodiments, and as previously referenced, the front outer surface layer 34 is optionally a single layer construction having head-cleaning functionality and including a head-cleaning agent component or a multi-layer construction including a functional head-cleaning layer as part of the front outer surface layer 34. Examples of useful head-cleaning agents include, but are not limited to, alumina, chromium dioxide, alpha iron oxide, and titanium dioxide particles of a size less than about 2 μm, less than 0.5 μm, or of other dimensions. Such head-cleaning agent particles generally have a Mohs hardness of greater than about 5, although other values are also acceptable. In some embodiments, the abrasive head-cleaning agent particles, alone and/or in agglomerated state, do not exceed an absolute size of about 1 to about 3 μm.

The head-cleaning agent component is dispersed in a solvent with a binder system, as well as other components, for example, a lubricant as referenced above, to form a fluid jet printable fluid dispersion. The head-cleaning agent dispersion is fluid jet printed over the substrate 16 onto the magnetic-recording layer 43, as part of a wet-on-wet or a wet-on-dry operation as desired. In some embodiments, the head-cleaning layer is specialized for head-cleaning functionality and is relatively highly comprised of head-cleaning agent particles. In some embodiments, the head-cleaning layer dispersion comprises about 20 wt % or more head-cleaning agent, although other values are contemplated. Additionally, and as referenced above in association with FIG. 4, the head-cleaning layer is optionally pattern printed to enhance head-cleaning functionality.

Fluid jet printing head-cleaning agents as a separate layer from the magnetic-recording layer 32, for example, can help reduce problems associated with the head-cleaning agent component(s) not being at or near the front face 26. For example, where head-cleaning agent particles are simply added to the magnetic-recording layer dispersion, such head-cleaning agent particles are typically not all at, or near, an outer surface of the magnetic-recording layer 32. Consequently, less efficient head-cleaning functionality is provided. Further, simply increasing the amount of head-cleaning agent in the magnetic-recording layer 32 (as is sometimes done in an effort to increase head-cleaning agent content at the outer surface of the magnetic-recording layer 32) can cause the electromagnetic properties or other properties of the magnetic-recording layer 32 to deteriorate.

In some embodiments, fluid jet printing a head-cleaning layer distinct from the magnetic-recording layer 32, and in particular, the front outer surface layer 34, allows a predetermined and controlled amount of head-cleaning agent to be deposited near the front face 26 without substantially reducing the electromagnetic properties of the magnetic-recording layer 32, or at least reducing the electromagnetic properties to a lesser extent than what would be needed to achieve a similar concentration of head-cleaning agent particles at the surface by incorporating the head-cleaning agent particles directly into the magnetic-recording layer dispersion.

Although in some embodiments the front outer surface layer 34 is formed over the substrate 16 onto the magnetic-recording layer 32 prior to reducing the magnetic-recording medium 10 to final format shape, in other embodiments the front outer surface layer 34 and/or portions thereof are formed following reduction of the magnetic-recording medium 10 to final format shape. Where the magnetic-recording medium 10 is adapted as a magnetic-recording tape, reduction to final format shape includes slitting the magnetic-recording medium 10 to a desired tape width, or final format width, and cutting the magnetic-recording medium 10 to a desired length, for example, a reel length of magnetic-recording tape. In some embodiments, during slitting one edge of the magnetic-recording medium 10 is formed as a “supported edge,” while an opposing edge of the width of magnetic-recording medium 10 is formed as an “unsupported edge.” Regardless, the magnetic-recording medium 10 is reduced and subsequently processed as desired.

With reference to FIGS. 6A and 6B, in some embodiments the magnetic-recording medium 10 is formed to define a cleaning section 600 adapted for aggressively cleaning a drive head. For example, in some embodiments, a portion of the front outer surface layer 34 is fluid jet printed to define a first, a second, and a third region 610, 612, 614 of the front face 26 for head-cleaning functionality, each of the regions 610, 612, 614 proximate the first end 12 (or the second end 14 as desired) of the magnetic-recording medium 10, with portions of the front face 26 adjacent the cleaning section 600 being substantially less abrasive in nature. Although the cleaning section 600 is formed subsequently to reduction of the magnetic-recording medium 10 to final format, it should be understood that similar patterns or compositions are optionally printed prior to reduction to final format as well or as an alternative.

Regardless, in some embodiments, the regions 610, 612, 614 cumulatively extend for a length of about 10 feet longitudinally, although other dimensions are contemplated. Each of the first, second, and third regions include abrasive particles, such as the head-cleaning agents referenced above. As illustrated in FIG. 6A, each of the regions 610, 612, 614 increase in particle size, respectively, such that in use, the magnetic-recording medium 10 goes from roughly abrading a tape drive head to finely abrading the tape drive head as the medium 10 is moved in the machine direction MD. In particular, the first region 610 includes particles of a first average size, the second region 612 includes particles of a second average size greater than the first average size, and the third region 614 includes particles of a third average size greater than the second average particle size, in some embodiments.

Furthermore, the pattern resolution of the regions 610, 612, 614 is additionally, or alternatively varied as shown in FIG. 6B between a first, a second, and a third resolution. In some embodiments, the first resolution is less than the second resolution, which in turn, is less than the third resolution. In some embodiments, by reducing the resolution of the head-cleaning layer print pattern, the tape drive head is first aggressively abraded and then fmely abraded as the tape is moved in the machine direction MD.

Thus, in some embodiments, rather than using a separate head-cleaning cartridge to aggressively clean a read/write head, the length of magnetic-recording medium 10 is optionally provided with self-cleaning functionality as part of a self-cleaning magnetic tape cartridge, for example.

Additionally, if desired, following reduction to final format width or at another appropriate stage in processing, a functional edge-finishing layer providing edge-finishing functionality can be formed over the substrate 16. For example, edges of the magnetic-recording medium 10 can be specifically targeted to remove debris, cracks, protrusions or other undesirable matter and/or structures. In some embodiments, chemical agents such as an etchant (e.g., an acid or a base in a liquid state), a solvent, or other appropriate edge-finishing agent is formed, e.g., fluid jet printed, over the substrate 16 onto the magnetic-recording medium 10 along edges of the magnetic-recording medium 10. In this manner, cracking, protrusions at the slit edges, debris, or other undesirable matter and structures of the substrate 16, functional layers, or foreign matter to the medium 10 can be substantially removed or reduced. In some embodiments, a chemical agent is used for substrate material. In turn, a solvent, such as MEK, is used for functional layer material in some embodiments. Regardless, in some embodiments, substrate and/or functional layer material is broken apart and/or removed from the magnetic-recording medium 10, for example, at edges of the magnetic-recording medium 10 or elsewhere, as desired.

In view of the above, it should be understood that it is contemplated that any of the components or materials associated with magnetic-recording medium 10 are optionally dispensed as a fluid or as a fluid dispersion via fluid jet printing. Additionally, it is contemplated that such printed layers can be fluid jet printed in the various patterns, thicknesses, and other layer constructions described herein. In accordance with this understanding, and although specific embodiments have been illustrated and described herein, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of producing magnetic-recording media, the method comprising:
providing a substrate;
forming a plurality of functional layers over the substrate to provide a coated substrate adapted for recording, including fluid jet printing at least one of the layers as a printed layer; and
reducing the coated substrate to a final format following formation of the plurality of functional layers over the substrate.

2. The method of claim 1, wherein the printed layer comprises a component adapted to serve as at least one of a head-cleaning agent and a load-bearing particle.

3. The method of claim 1, wherein the printed layer is adapted to serve as at least one of an adhesion priming layer, a surface-cleansing layer, an edge-finishing layer, a reaction-promoting layer, and a lubricating layer.

4. The method of claim 1, wherein forming the plurality of layers includes:
forming one or more layers of the plurality of layers over the substrate:
drying the one or more layers; and
fluid jet printing the printed layer over the one or more dried layers.

5. The method of claim 1, further comprising:
forming one or more layers of the plurality of layers over the substrate;
calendering the one or more layers; and
fluid jet printing the printed layer over the one or more calendered layers.

6. The method of claim 1, further comprising:
printing a first portion of the printed layer at a first resolution; and
printing a second portion of the printed layer at a second resolution, the second resolution different from the first resolution.

7. The method of claim 1, wherein the printed layer printed is flood printed to substantially continuously cover a surface onto which the printed layer is deposited.

8. The method of claim 1, wherein the coated substrate is moved in a machine direction during formation of the plurality of layers and further wherein the printed layer defines a pre-selected pattern in the machine direction.

9. The method of claim 1, wherein the substrate is moved in a machine direction during formation of the plurality of layers, and further wherein the printed layer defines a pre-selected gradient in thickness in the machine direction.

10. The method of claim 1, wherein at least one of the plurality layers is a magnetic-recording layer comprising a magnetic component and the printed layer includes a head-cleaning agent, and further wherein the printed layer is printed over the magnetic-recording layer.

11. The method of claim 1, wherein at least one of the plurality of layers defines a back sublayer comprising a carbon black component, the printed layer includes a load-bearing particle component, and the printed layer is printed over the back sublayer.

12. A method of producing a magnetic-recording media, the method comprising:
forming a plurality of layers over a substrate to provide a coated substrate having a first face and a second face opposite the first face;
wherein the plurality of layers comprise a printed layer formed by fluid jet printing, the fluid jet printed layer comprising at least one of a head-cleaning agent, a load-bearing particle component, a magnetic component, a lubricant, an edge-finishing agent, and a reaction-promoting component.

13. The method of claim 12, further comprising:
fluid jet printing at least a portion of one of the plurality of layers at a predetermined gradient in thickness.

14. The method of claim 12, further comprising:
fluid jet printing at least a portion of one of the plurality of layers at a first resolution; and
fluid jet printing at least a portion of one of the plurality of layers at a second resolution, the second resolution different than the first resolution.

15. The method of claim 12, wherein the coated substrate is magnetic-recording tape having a cleaning section formed at a pre-selected position, the method further comprising:
fluid jet printing the cleaning section;
wherein the cleaning section defines a portion of the first face, the portion of the first face having a substantially greater abrasive particle concentration than an adjacent portion of the first face.

16. The method of claim 12, wherein the plurality of layers further define a magnetic-recording layer, and further wherein the printed layer is formed onto the magnetic-recording layer.

17. A magnetic-recording medium comprising:
a nonmagnetic substrate;
a plurality of layers formed over the substrate to define a coated substrate, at least one of the plurality of layers formed via fluid jet printing as a printed layer;
wherein the printed layer provides at least one of load-bearing functionality, head-cleaning functionality, adhesion-promoting functionality, reaction-promoting functionality, lubricating functionality, and magnetic-recording functionality.

18. The magnetic-recording medium of claim 17, wherein the coated substrate defines a longitudinal direction, and further wherein the printed layer defines a pre-selected pattern in the longitudinal direction.

19. The magnetic-recording medium of claim 17, wherein the coated substrate defines a longitudinal direction, and further wherein the printed layer defines a pre-selected gradient in thickness in the longitudinal direction.

20. The magnetic-recording medium of claim 17, wherein the coated substrate is magnetic-recording tape.
